(19) United States
(12) Patent Application Publication
(10) Pub. No.: US 2022/0170759 A1
(43) Pub. Date: Jun. 2, 2022

(54) NAVIGATION SERVER, NAVIGATION PROGRAM, AND NAVIGATION SYSTEM

(71) Applicant: TOYOTA JIDOSHA KABUSHIKI KAISHA, Toyota-shi (JP)

(72) Inventors: Ayano KIMURA, Susono-shi (JP); Hikaru SHIOZAWA, Susono-shi (JP); Toshiya HASHIMOTO, Miyoshi-shi (JP); Chuya OGAWA, Susono-shi (JP); Yuta MANIWA, Susono-shi (JP)

(73) Assignee: TOYOTA JIDOSHA KABUSHIKI KAISHA, Toyota-shi (JP)

(21) Appl. No.: 17/469,337

(22) Filed: Sep. 8, 2021

(30) Foreign Application Priority Data
Nov. 30, 2020 (JP) 2020-198875

(51) Int. Cl. G01C 21/36; G01C 21/34

(52) U.S. Cl. CPC G01C 21/3679; G01C 21/3647; G01C 21/3602; G01C 21/3469

(57) ABSTRACT

Provided is a processor configured to, when a guidance target vehicle is unable to travel a charging area that is provided between a first point and a second point and that is for performing charging of an in-vehicle battery, output to the guidance target vehicle guidance information of a first route including the first point and the second point and not including the charging area, and when the guidance target vehicle is able to travel the charging area, output to the guidance target vehicle guidance information of a second route including the first point, the charging area, and the second point.

### CROSS-REFERENCE TO RELATED APPLICATION

This application claims priority to Japanese Patent Application No. 2020-198875 filed on Nov. 30, 2020, incorporated herein by reference in its entirety.

### BACKGROUND

### 1. Technical Field

The present disclosure relates to a navigation server, a navigation program, and a navigation system.

### 2. Description of Related Art

WO 2011/142421 discloses a technique of guiding an electric vehicle that requires charging to travel on a power supply lane.

### SUMMARY

A technique has been demanded that can increase the flexibility of the route on which guidance is provided to a guidance target vehicle.

The present disclosure has been made in view of the above, and an object thereof is to provide a navigation server, a navigation program, and a navigation system that are all capable of increasing the flexibility of the route on which guidance is provided to the guidance target vehicle.

A navigation server according to the present disclosure includes a processor configured to when a guidance target vehicle is unable to travel a charging area that is provided between a first point and a second point and that is for performing charging of an in-vehicle battery, output to the guidance target vehicle guidance information of a first route including the first point and the second point and not including the charging area, and when the guidance target vehicle is able to travel the charging area, output to the guidance target vehicle guidance information of a second route including the first point, the charging area, and the second point.

A navigation program according to the present disclosure causes a processor to, when a guidance target vehicle is unable to travel a charging area that is provided between a first point and a second point and that is for performing charging of an in-vehicle battery, output to the guidance target vehicle guidance information of a first route including the first point and the second point and not including the charging area, and when the guidance target vehicle is able to travel the charging area, output to the guidance target vehicle guidance information of a second route including the first point, the charging area, and the second point.

A navigation system according to the present disclosure includes: a guidance target vehicle including a first processor; and a navigation server including a second processor configured to, when the guidance target vehicle is unable to travel a charging area that is provided between a first point and a second point and that is for performing charging of an in-vehicle battery, output to the guidance target vehicle guidance information of a first route including the first point and the second point and not including the charging area, and when the guidance target vehicle is able to travel the charging area, output to the guidance target vehicle guidance information of a second route including the first point, the charging area, and the second point.

According to the present disclosure, an effect is provided that the flexibility of the route on which guidance is provided to the guidance target vehicle can be increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a navigation system according to an embodiment;

FIG. 2 is a block diagram schematically showing a configuration of the navigation system according to the embodiment;

FIG. 3 is an explanatory diagram of a route guidance to an electric vehicle;

FIG. 4 is a diagram showing a case in which guidance of a first route is provided to the electric vehicle;

FIG. 5 is a diagram showing a case in which guidance of a second route is provided to a guidance target vehicle;

FIG. 6 is a diagram showing a route guidance control routine executed by the navigation system according to the embodiment;

FIG. 7 is a flowchart showing an example of a travel possibility determination process for a charging area; and

FIG. 8 is a flowchart showing an example of a route selection process.

### DETAILED DESCRIPTION OF EMBODIMENTS

An embodiment of a navigation server, a navigation program, and a navigation system according to the present disclosure will be described below. Note that the present embodiment does not limit the present disclosure.

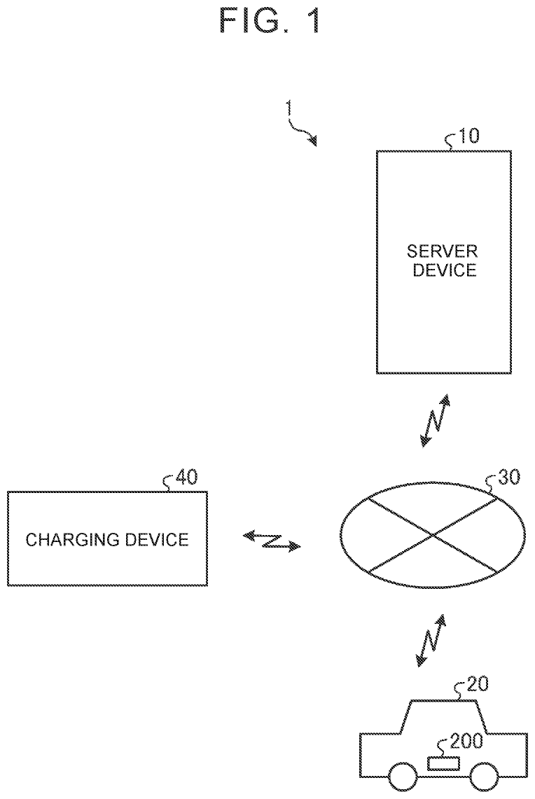

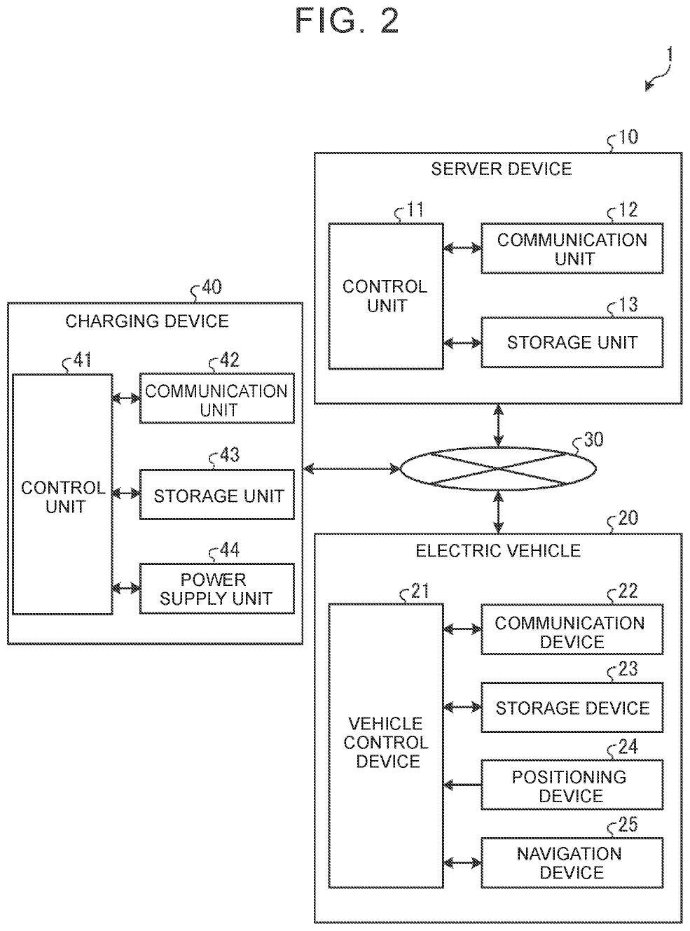

FIG. 1 is a diagram schematically showing a navigation system 1 according to the embodiment. FIG. 2 is a block diagram schematically showing a configuration of the navigation system 1 according to the embodiment.

As shown in FIG. 1, the navigation system 1 includes a server device 10, an electric vehicle 20, a network 30, and a charging device 40.

The server device 10, the electric vehicle 20, and the charging device 40 are configured to be able to communicate with each other through the network 30 that is an external communication network. The network 30 includes, for example, the Internet and a mobile phone network.

The server device 10 functions as a navigation server and includes a control unit 11, a communication unit 12, and a storage unit 13, as shown in FIG. 2.

The control unit 11 specifically includes: a processor including a central processing unit (CPU), a digital signal processor (DSP), a field-programmable gate array (FPGA), and the like; and a memory (main storage unit) including a random access memory (RAM), a read only memory (ROM), and the like. The control unit 11 loads a program stored in the storage unit 13 into the work area of the main storage unit to execute the program, and controls various components and the like through the execution of the program so as to realize the function that satisfies a predetermined purpose.

For example, the control unit 11 executes a navigation program to calculate a route on which the electric vehicle 20 travels. The control unit 11 also sets a charging device search range based on the cruising range of the electric vehicle 20 or the like, searches for the charging device 40 included in the charging device search range, and selects the charging device 40 to use for charging. Further, the control unit 11 selects a charging mode for charging an in-vehicle battery 200 of the electric vehicle 20. Further, the control unit 11 selects a charging space on which guidance is provided to the electric vehicle 20, based on the charging mode of the electric vehicle 20.

The communication unit 12 includes a local area network (LAN) interface board and a wireless communication circuit for wireless communication, for example. The communication unit 12 is connected to the network 30 such as the Internet that is a public communication network. The communication unit 12 connects to the network 30 so as to communicate with the electric vehicle 20 and the charging device 40.

The storage unit 13 includes a recording medium such as an erasable programmable ROM (EPROM), a hard disk drive (HDD), and a removable medium. Examples of the removable medium include a universal serial bus (USB) memory and a disc recording media such as a compact disc (CD), a digital versatile disc (DVD), and a Blu-ray (registered trademark) disc (BD). The storage unit 13 can store an operating system (OS), various programs, various tables, various databases, and the like.

The storage unit 13 may temporarily store calculation results and the like by the control unit 11. The storage unit 13 may also store information on a state of charge (SOC) of the electric vehicle 20 and the like that is acquired by the server device 10 through communication with the electric vehicle 20. The storage unit 13 may also store charging device information acquired by the server device 10 through communication with the charging device 40. Examples of the charging device information include the name of the charging device, the position (for example, latitude and longitude) of the charging device, the charging capacity (for example, rapid charging or normal charging), the charging mode (for example, non-contact charging, direct-current (DC) charging, or alternating current (AC) charging), and the usage of the charging device.

The electric vehicle 20 is, for example, an electric vehicle (EV) or a plug-in hybrid electric vehicle (PHEV). The electric vehicle 20 is provided with a vehicle control device 21, a communication device 22, a storage device 23, a positioning device 24, and a navigation device 25. The vehicle control device 21 and the storage device 23 are physically the same as the control unit 11 and the storage unit 13 of the server device 10, respectively.

The vehicle control device 21 is an electronic control unit (ECU) that collectively controls the operation of various components mounted on the electric vehicle 20. The communication device 22 includes, for example, a data communication module (DCM), and communicates with the server device 10 by wireless communication through the network 30. The storage device 23 stores information on the vehicle position detected by the positioning device 24 (hereinafter, referred to as vehicle position information) as necessary.

The positioning device 24 receives radio waves from Global Positioning System (GPS) satellites to detect the vehicle position information. In response to this, the vehicle control device 21 periodically transmits the vehicle position information to the server device 10 through the network 30. Note that the detection method of the vehicle position information is not limited to the method using GPS satellites, and for example, a method in which a light detection and ranging or laser imaging detection and ranging (LiDAR) and a three-dimensional digital map are combined or the like may be used.

The navigation device 25 inputs and outputs data such as map information and travel route information, a navigation program, and the like from and to the vehicle control device 21. Thus, the vehicle control device 21 supplies various command signals to the components constituting the electric vehicle 20 so as to cause the electric vehicle 20 to travel. Note that the navigation device 25 itself may include a control unit and a recording medium such as a CPU, a RAM, and a ROM.

The navigation device 25 is provided with an input-output unit such as a touch panel display and a speaker microphone. The input-output unit notifies the outside of predetermined information by displaying characters, figures, and the like on the screen of the touch panel display or outputting voice from the speaker microphone with the control by the vehicle control device 21. Further, the input-output unit inputs predetermined information to the vehicle control device 21, when the occupant of the electric vehicle 20 operates the touch panel display or outputs a voice to the speaker microphone.

The navigation system 1 according to the embodiment displays a route to the charging space (charging device 40) searched and selected by the server device 10 on the screen of the touch panel display of the navigation device 25, for example. That is, the navigation system 1 according to the embodiment presents the information on the charging space (charging device 40) to the occupant of the electric vehicle 20 through the touch panel display of the navigation device 25.

Note that the electric vehicle 20 includes, in addition to the configuration shown in FIG. 2, an inverter, a motor, the in-vehicle battery 200, and the like. The vehicle control device 21 of the electric vehicle 20 can detect the information on the SOC and transmits the information on the SOC to the server device 10 as necessary.

The charging device 40 includes a control unit 41, a communication unit 42, a storage unit 43, and a power supply unit 44. The control unit 41 specifically includes: a processor including a CPU, a DSP, an FPGA, and the like; and a memory including a RAM, a ROM, and the like. The control unit 41 loads the program stored in the storage unit 43 into the work area of the memory to execute the program, and controls various components (for example, controls charging function such as power supply with the power supply unit 44) through the execution of the program so as to realize the function that satisfies a predetermined purpose.

For example, the communication unit 42 includes a LAN interface board, a wireless communication circuit for wireless communication, and the like. The communication unit 42 is connected to the network 30. The communication unit 42 connects to the network 30 to communicate with the server device 10 and the electric vehicle 20.

The storage unit 43 includes a recording medium such as an EPROM, a hard disk drive, and a removable medium. Examples of the removable medium include, for example, a USB memory and a disk recording medium such as a CD, a DVD, and a BD. The storage unit 43 can store an operating system (OS), various programs, various tables, various databases, and the like.

The storage unit 43 may store the information on the charging device 40 (charging device information). Examples of the information on the charging device 40 include the name of the charging device 40, the position of the charging device 40 (for example, latitude, longitude, and, area), the charging capacity (for example, rapid charging or normal charging), the charging mode (for example, non-contact charging, DC charging, or AC charging), and the usage of the charging device 40.

For the power supply unit 44, a known configuration such as a non-contact power supply mode, a DC power supply mode, or an AC power supply mode can be employed. When the power supply unit 44 is of the non-contact power supply mode, electric power is supplied from the power supply unit 44 to a power receiving unit provided in the electric vehicle 20, thereby charging the in-vehicle battery 200 of the electric vehicle 20. When the power supply unit 44 is of the DC charging mode, the charging device 40 and the electric vehicle 20 are connected with a charging cable and DC power is supplied from the power supply unit 44 via the charging cable, thereby charging the in-vehicle battery 200 of the electric vehicle 20. When the power supply unit 44 is of the AC charging mode, the charging device 40 and the electric vehicle 20 are connected with a charging cable and AC power is supplied from the power supply unit 44 via the charging cable, thereby charging the in-vehicle battery 200 of the electric vehicle 20.

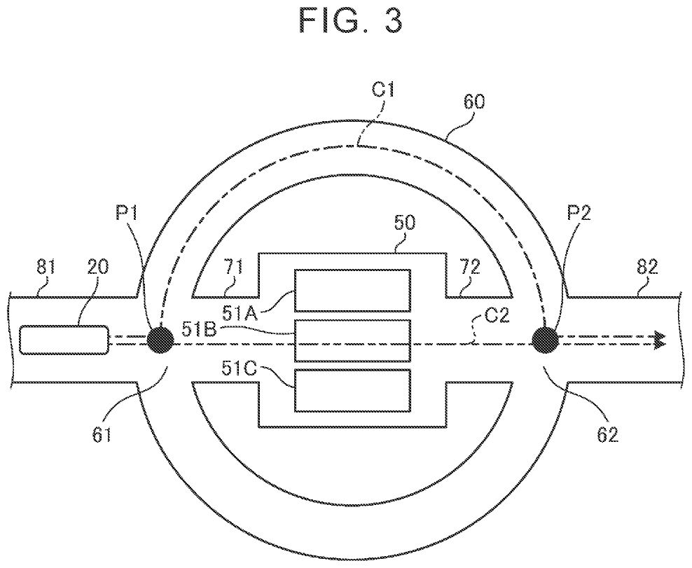

FIG. 3 is an explanatory diagram of a route guidance to the electric vehicle 20. In FIG. 3, a charging area 50 for charging the in-vehicle battery 200 and an annular road 60 that is an annular traveling road on which the electric vehicle 20 travels are provided. The charging area 50 is provided inside the annular road 60. The charging area 50 includes three charging spaces 51A, 51B, 51C each having the charging device 40. In each of the charging spaces 51A, 51B, 51C, one electric vehicle 20 can be parked to be charged by the charging device 40. The electric vehicle 20 enters or exits the charging spaces 51A, 51B, 51C through a first communication passage 71 or a second communication passage 72 connected to the charging area 50.

An end portion of each of the first communication passage 71 and the second communication passage 72 on the opposite side from the side on which the first communication passage 71 or the second communication passage 72 is connected to the charging area 50 is connected to the inner peripheral side of the annular road 60. A first traveling road 81 is connected to a first intersection 61 that is a connection portion of the annular road 60 and the first communication passage 71, from the outer peripheral side of the annular road 60. A second traveling road 82 is connected to a second intersection 62 that is a connection portion of the annular road 60 and the second communication passage 72, from the outer peripheral side of the annular road 60. The first traveling road 81, the first intersection 61, the first communication passage 71, the charging area 50, the second communication passage 72, the second intersection 62, and the second traveling road 82 are positioned substantially on the same straight line.

In the present embodiment, as points through which the electric vehicle 20 passes when traveling from the first traveling road 81 to the second traveling road 82, a first point P1 is set in the first intersection 61 and a second point P2 is set in the second intersection 62. Further, in the present embodiment, as routes for the electric vehicle 20 to move between the first point P1 and the second point P2, for example, a first route C1 extending from the first point P1 to the second point P2 through the annular road 60 and a second route C2 extending from the first point P1 to the second point P2 through the first communication passage 71, the charging area 50, and the second communication passage 72 are set. The second route C2 connects the first point P1 and the second point P2 in a straight line. Therefore, the second route C2 has a shorter distance between the first point P1 and the second point P2 than the first route C1 connecting the first point P1 and the second point P2 in a curved line (semicircle).

Note that the charging area 50 and the annular road 60 may be provided underground, for example. The annular road 60 is used as a traveling road on which the electric vehicle 20 serving as a transportation vehicle for transporting packages travels. Further, the charging area 50 is used not only as a charging location for the electric vehicle 20 but also as a waiting area during the nighttime for the electric vehicle 20 that travels on the ground during the daytime.

In the navigation system 1 according to the embodiment, in FIG. 3 for example, when it is determined that the electric vehicle 20 that is a guidance target vehicle to which guidance is provided from the server device 10 is unable to travel the charging area 50, guidance of the first route C1 is provided to the electric vehicle 20, and when it is determined that the electric vehicle 20 is able to travel the charging area 50, guidance of the second route C2 is provided to the electric vehicle 20.

Note that when there is a vehicle in the charging area 50, the server device 10 determines that the electric vehicle 20 is unable to travel the charging area 50. The server device 10 determines that the electric vehicle 20 is able to travel the charging area 50 when there is no vehicle in the charging area 50. Further, whether there is a vehicle in the charging area 50 is determined, for example, based on the usage of the charging device 40 provided in the charging area 50. Note that the usage of the charging device 40 is, for example, whether the charging device 40 is in use. Further, whether there is a vehicle in the charging area 50 is determined, for example, based on an image captured by an imaging unit such as a camera provided in the charging area 50. Note that the image captured by the imaging unit, for example, is transmitted from the imaging unit to the server device 10 via the network 30.

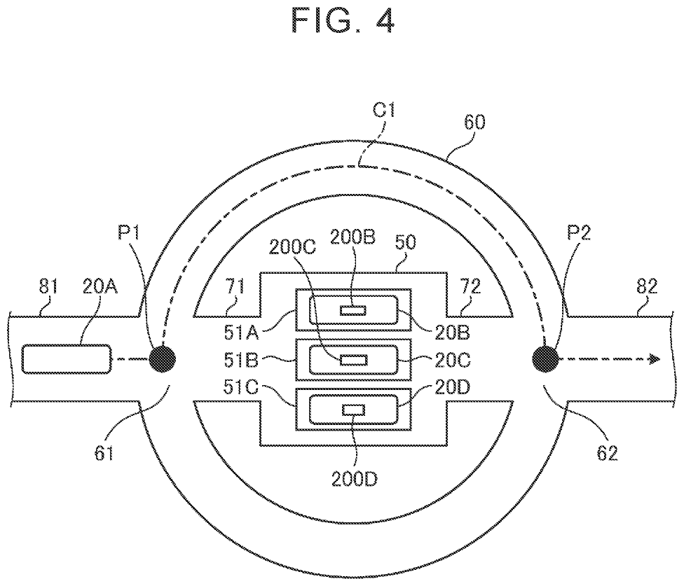

FIG. 4 is a diagram showing a case in which the guidance of the first route C1 is provided to an electric vehicle 20A. In FIG. 4, the guidance target vehicle to which guidance of a route is provided from the server device 10 is the electric vehicle 20A. In the charging spaces 51A, 51B, 51C provided in the charging area 50, electric vehicles 20B, 20C, 20D are parked to charge their respective in-vehicle batteries 200B, 200C, 200D. That is, in the charging area 50, there are the electric vehicles 20B, 20C, 20D that can hinder the traveling of the electric vehicle 20A that is the guidance target vehicle. Therefore, when the electric vehicle 20A moves from the first point P1 to the second point P2, the server device 10 determines that the electric vehicle 20A is unable to travel the charging area 50. When the electric vehicle 20A is unable to travel the charging area 50 in this way, the guidance of the first route C1 is provided from the server device 10 to the electric vehicle 20A so that the electric vehicle 20 moves from the first point P1 to the second point P2 by traveling the annular road 60.

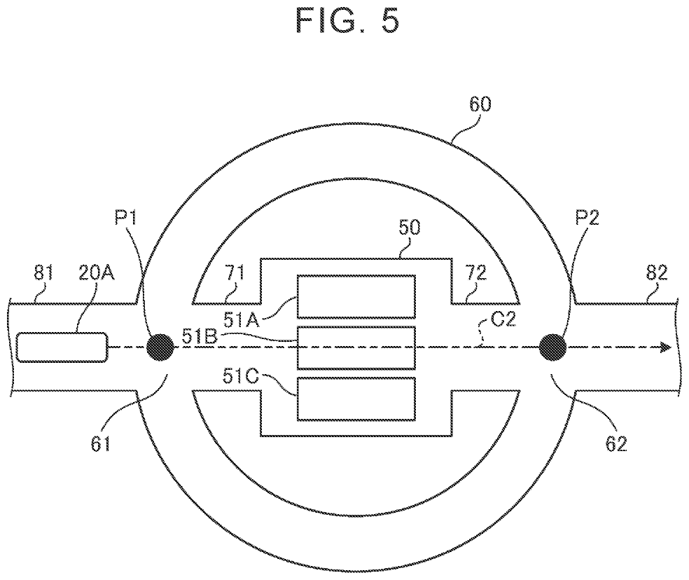

FIG. 5 is a diagram showing a case in which the guidance of the second route C2 is provided to the electric vehicle 20A. In FIG. 5, there is no vehicle parked in the charging spaces 51A, 51B, 51C provided in the charging area 50, which means that there is no vehicle in the charging area 50. In the case where there is no vehicle in the charging area 50 in this way, when the electric vehicle 20A that is the guidance target vehicle moves from the first point P1 to the second point P2, the server device 10 determines that the electric vehicle 20A is able to travel the charging area 50. When the electric vehicle 20A is able to travel the charging area 50 in this way, the guidance of the second route C2 is provided from the server device 10 to the electric vehicle 20A so that the electric vehicle 20A moves from the first point P1 to the second point P2 by traveling the first communication passage 71, the charging area 50, and the second communication passage 72.

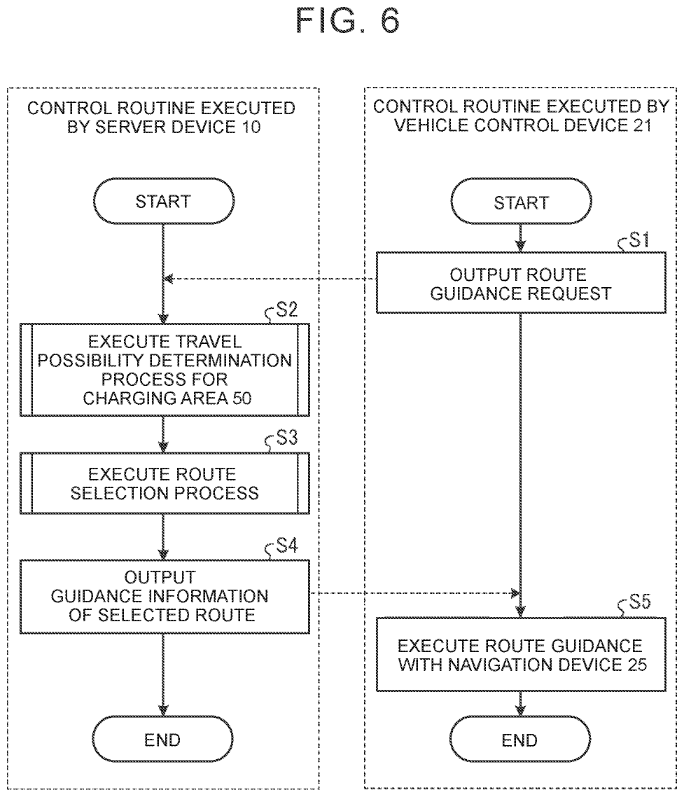

FIG. 6 is a diagram showing a route guidance control routine executed by the navigation system 1 according to the embodiment. The route guidance control routine shown in FIG. 6 is executed by collaboration of the server device 10 and the vehicle control device 21 of the electric vehicle 20A, and includes a control routine executed by the server device 10 and a control routine executed by the vehicle control device 21 of the electric vehicle 20A.

When this routine starts, the vehicle control device 21 outputs a route guidance request to the server device 10 in step S1. Next, in step S2, the server device 10 executes a travel possibility determination process for the charging area 50.

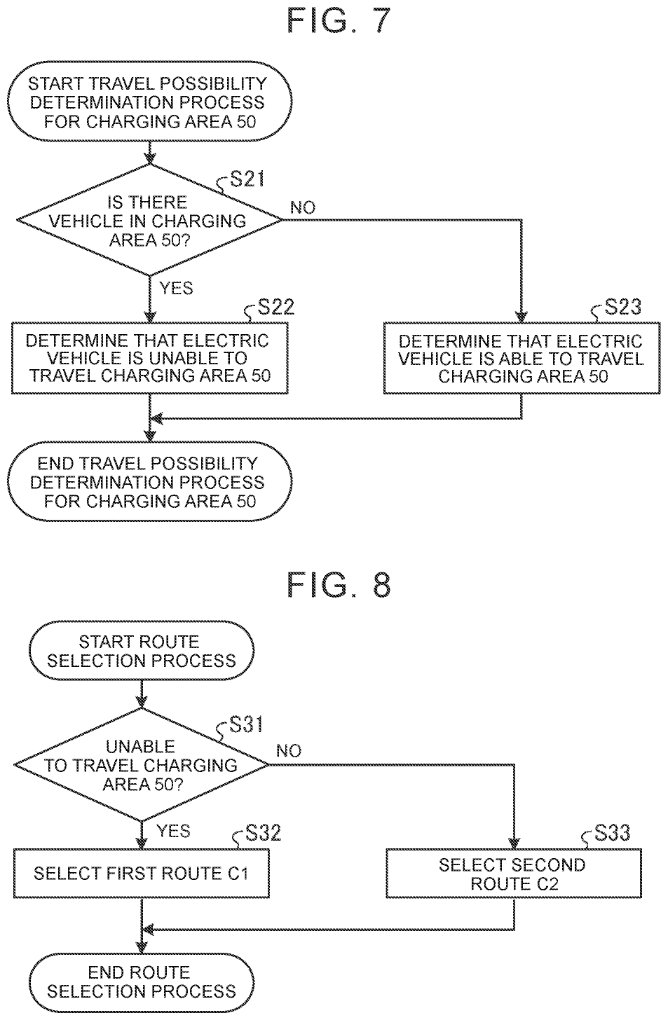

FIG. 7 is a flowchart showing an example of the travel possibility determination process for the charging area 50. When the travel possibility determination process for the charging area 50 is started, the server device 10 determines in step S21 whether there is a vehicle in the charging area 50. When determining that there is a vehicle in the charging area 50 (Yes in step S21), the server device 10 determines, in step S22, that the electric vehicle 20A is unable to travel the charging area 50 and ends the travel possibility determination process for the charging area 50. On the other hand, when determining that there is no vehicle in the charging area 50 (No in step S21), the server device 10 determines, in step S23, that the electric vehicle 20A is able to travel the charging area 50 and ends the travel possibility determination process for the charging area 50.

In FIG. 6, after executing the travel possibility determination process for the charging area 50, the server device 10 executes a route selection process in step S3.

FIG. 8 is a flowchart showing an example of a route selection process. When the route selection process is started, the server device 10 determines, in step S31, whether the electric vehicle 20A is unable to travel the charging area 50. When determining that the electric vehicle 20A is unable to travel the charging area 50 (Yes in step S31), the server device 10 selects the first route C1 in step S32 and ends the route selection process. On the other hand, when determining that the electric vehicle 20A is able to travel the charging area 50 (No in step S31), the server device 10 selects the second route C2 in step S33 and ends the route selection process.

In FIG. 6, the server device 10 outputs to the vehicle control device 21 the guidance information of the selected route (first route C1 or second route C2) in step S4, and ends the routine. Next, in step S5, the vehicle control device 21 executes the route guidance with the navigation device 25 of the electric vehicle 20A based on the guidance information of the acquired route (first route C1 or second route C2), and ends the routine. Note that when the electric vehicle 20 is provided with an autonomous driving function for performing autonomous traveling, the vehicle control device 21 causes the electric vehicle 20A to travel autonomously following the route guidance.

In the navigation system 1 according to the embodiment, when the electric vehicle 20A that is a guidance target vehicle moves from the first point P1 to the second point P2, the route on which guidance is provided from the server device 10 to the electric vehicle 20A is selected from the first route C1 and the second route C2 based on whether the electric vehicle 20A is able to travel the charging area 50. That is, the server device 10 provides the guidance of the first route C1 to the electric vehicle 20A when the electric vehicle 20A is unable to travel the charging area 50, and provides the guidance of the second route C2 to the electric vehicle 20 when the electric vehicle 20A is able to travel the charging area 50. Thus, when the electric vehicle 20A moves from the first point P1 to the second point P2, it is possible to increase the flexibility of the route on which guidance is provided to the electric vehicle 20A, compared with the case where guidance of only the first route C1 can be provided to the electric vehicle 20A regardless of whether the electric vehicle 20A is able to travel the charging area 50. Further, in the present embodiment, the second route C2 has a shorter distance between the first point P1 and the second point P2 than the first route C1. Thus, by providing the guidance of the second route C2 to the electric vehicle 20A when the electric vehicle 20A is able to travel the charging area 50, it is possible to shorten the moving distance of the electric vehicle 20A compared with the case where the guidance of the first route C1 is provided to the electric vehicle 20A.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. A navigation server, comprising a processor configured to, when a guidance target vehicle is unable to travel a charging area that is provided between a first point and a second point and that is for performing charging of an in-vehicle battery, output to the guidance target vehicle guidance information of a first route including the first point and the second point and not including the charging area, and when the guidance target vehicle is able to travel the charging area, output to the guidance target vehicle guidance information of a second route including the first point, the charging area, and the second point.

2. The navigation server according to claim 1, wherein the processor determines that the guidance target vehicle is unable to travel the charging area when determining that there is a vehicle in the charging area, and determines that the guidance target vehicle is able to travel the charging area when determining that there is no vehicle in the charging area.

3. The navigation server according to claim 2, wherein the processor determines whether there is a vehicle in the charging area based on usage of a charging device provided in the charging area.

4. The navigation server according to claim 2, wherein the processor determines whether there is a vehicle in the charging area based on a captured image of the charging area.

5. The navigation server according to claim 1, wherein:
the charging area is provided inside an annular road; and
the processor outputs to the guidance target vehicle guidance information of a route passing through the annular road, as the guidance information of the first route.

6. The navigation server according to claim 1, wherein the processor communicates with the guidance target vehicle via an external communication network.

7. A navigation program that causes a processor to, when a guidance target vehicle is unable to travel a charging area that is provided between a first point and a second point and that is for performing charging of an in-vehicle battery, output to the guidance target vehicle guidance information of a first route including the first point and the second point and not including the charging area, and when the guidance target vehicle is able to travel the charging area, output to the guidance target vehicle guidance information of a second route including the first point, the charging area, and the second point.

8. The navigation program according to claim 7 that causes the processor to determine that the guidance target vehicle is unable to travel the charging area when determining that there is a vehicle in the charging area, and determine that the guidance target vehicle is able to travel the charging area when determining that there is no vehicle in the charging area.

9. The navigation program according to claim 8 that causes the processor to determine whether there is a vehicle in the charging area based on usage of a charging device provided in the charging area.

10. The navigation program according to claim 8 that causes the processor to determine whether there is a vehicle in the charging area based on a captured image of the charging area.

11. The navigation program according to claim 7, wherein:
the charging area is provided inside an annular road; and
the navigation program causes the processor to output to the guidance target vehicle guidance information of a route passing through the annular road, as the guidance information of the first route.

12. A navigation system, comprising:
a guidance target vehicle including a first processor; and
a navigation server including a second processor configured to, when the guidance target vehicle is unable to travel a charging area that is provided between a first point and a second point and that is for performing charging of an in-vehicle battery, output to the guidance target vehicle guidance information of a first route including the first point and the second point and not including the charging area, and when the guidance target vehicle is able to travel the charging area, output to the guidance target vehicle guidance information of a second route including the first point, the charging area, and the second point.

13. The navigation system according to claim 12, wherein the second processor determines that the guidance target vehicle is unable to travel the charging area when determining that there is a vehicle in the charging area, and determines that the guidance target vehicle is able to travel the charging area when determining that there is no vehicle in the charging area.

14. The navigation system according to claim 13, wherein the second processor determines whether there is a vehicle in the charging area based on usage of a charging device provided in the charging area.

15. The navigation system according to claim 14, wherein the charging device performs charging of the in-vehicle battery in a non-contact charging mode.

16. The navigation system according to claim 13, wherein the second processor determines whether there is a vehicle in the charging area based on a captured image of the charging area.

17. The navigation system according to claim 12, wherein:
the charging area is provided inside an annular road; and
the second processor outputs to the guidance target vehicle guidance information of a route passing through the annular road, as the guidance information of the first route.

18. The navigation system according to claim 17, wherein the charging area and the annular road are provided underground.

19. The navigation system according to claim 18, wherein the charging area also serves as a waiting area for a vehicle.

20. The navigation system according to claim 12, wherein the first processor causes the guidance target vehicle to autonomously travel based on the guidance information of the first route or the second route output from the navigation server.
